(19) United States
(12) Patent Application Publication
(10) Pub. No.: US 2008/0062963 A1
(43) Pub. Date: Mar. 13, 2008

(54) Composite internet phone device

(76) Inventor: Ming-Hui Huang, Taipei City (TW)

Correspondence Address: RABIN & Berdo, PC, 1101 14TH STREET, NW, SUITE 500, WASHINGTON, DC, 20005, US

(21) Appl. No.: 11/504,649

(22) Filed: Aug. 16, 2006

(51) Int. Cl. H04L 12/66

(52) U.S. Cl. 370/352

(57) ABSTRACT

A composite Internet phone device is provided, which is a phone device formed by compositing an Internet phone module with a conventional phone, and used for communication service of voice over Internet Protocol (VOIP) and public switched telephone network (PSTN), wherein it is selectively switched to one of the VOIP and PSTN by a switching unit according to power supplying conditions of a power-supplying device for an Internet phone or networks of the called party and the calling party.

### BACKGROUND OF THE INVENTION

1. Field of Invention

The present invention relates to a phone device, and more particularly to, a phone device suitable for public switched telephone network (PSTN) and voice over Internet protocol (VOIP).

2. Related Art

The voice over Internet protocol (VOIP) is a protocol of transmitting sound/video by utilizing an open network, and providing communication service through signals in packet, which may save a lot of call charges just like transmitting information over Internet. However, the Internet phone is restricted by many factors of the Internet, such that the quality of the communication is relatively unstable, thereby resulting in problems of unclear signals or disconnection.

The conventional phone has been generally used in daily phone communication, and the analog phone set is coupled to the public switched telephone network (PSTN) for providing communication service. Although the conventional phone has a high call charge, it is not restricted by many factors of the Internet as the Internet phone. Additionally, the conventional phone is not influenced by the power failure, but also can be used during the power failure. Therefore, although the Internet phone gradually becomes prevailing, in practice, its application must be essentially supported by the conventional phone so as to meet the actual requirements of the user.

Please refer to FIG. 1 of a schematic view of a conventional Internet phone composite with a PSTN. As shown in FIG. 1, the composite Internet phone device 10 comprises an Internet phone system 101, a hook circuit 102, a keypad 103, a receiver 104, and a foreign exchange office (FXO) 105. The composite Internet phone device 10 is connected to the VOIP 11 via the Internet phone system 101, and it is connected to the PSTN 12 via the FXO 105. When a user wants to dial an Internet phone via the composite Internet phone device 10 as conventionally dialing a phone number, the user triggers the hook circuit 102 after picking up the receiver 104, and dials the number via the keypad 103. The Internet phone system 101 is determined to dial to either VOIP 11 or PSTN 12 according to the dialing content or particularly defined keys. If dialing to the VOIP 11, it enters to the VOIP 11 via the Internet phone system 101, and then connected to the communication destination. On the other aspect, if dialing to the PSTN 12, the composite Internet phone device 10 forms a telecommunication loop with the PSTN 12, and the phone number is dialed via the keypad 103, and then it enters to the PSTN 12 via the Internet phone system 101 and the FXO 105, and then is connected to the communication destination. Therefore, once the electric power is used out or the power failure occurs for the Internet phone system 101, it cannot be connected to the PSTN 12 via the Internet phone system 101.

Please refer to FIG. 2 of a schematic view of a conventional Internet phone composite with a conventional phone. As shown in FIG. 2, the composite Internet phone device 20 comprises an Internet phone system 201, a FXO 202, and a foreign exchange station (FXS) 203. The composite Internet phone device 20 is connected to the VOIP 11 via the Internet phone system 201, connected to the PSTN 12 via the FXO 202, and connected to the conventional phone device 21 via the FXS 203.

The conventional phone device 21 comprises a conventional phone system 211, a hook circuit 212, a keypad 213, and a receiver 214. The conventional phone device 21 has the same function as that of the conventional phone, for example, dialing to the PSTN 12. The conventional phone device 21 is connected to the Internet phone device 20 via the FXS 203 thereof, such that the conventional phone device 21 is connected to the PSTN 12 via the FXO 202 of the Internet phone system 201, and further connected to the VOIP 11 via the FXS 203. As shown in the figure, the conventional technical further comprises a switching unit 22. The switching unit 22 is used to connect the conventional phone device 21 to the PSTN 12, and the switching unit 22 is further connected to the FXO 202 and the FXS 203 of the Internet phone device 20. Therefore, when the Internet phone device 20 cannot be used to connect the conventional phone device 21 to the PSTN 12 due to the insufficient electric power or power failure, the switching unit 22 switches to the external connection of the conventional phone device 21, and the conventional phone device 21 is connected to the PSTN 12 via the switching unit 22 itself, and supplied by the electric power from the PSTN 12. The conventional technical solves the problem of power switching during the integration of the Internet phone. However, since the Internet phone device 20, the conventional phone device 21, and the switching unit 22 are isolated devices, when they are integrated for being used, each of them must be connected to each other, which is inconvenient for the user.

### SUMMARY OF THE INVENTION

In order to solve the above problems, the present invention discloses a composite Internet phone device, which is formed by integrating an Internet phone device with a conventional phone device, and each component is integrated within a single frame.

The composite Internet phone utilizes a keypad to dial numbers via the voice over Internet Protocol (VOIP) phone network and the public switched telephone network (PSTN), and it is connected to the PSTN via the existed FXO of the conventional phone, or connected to the VOIP phone network via the Internet phone system, and switches between the Internet phone mode and the conventional phone mode by utilizing a switching unit, and further isolates the Internet phone device and the conventional phone device by utilizing the isolation device, so as to ensure the safety of communication.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic view of a conventional Internet phone composite with a PSTN;

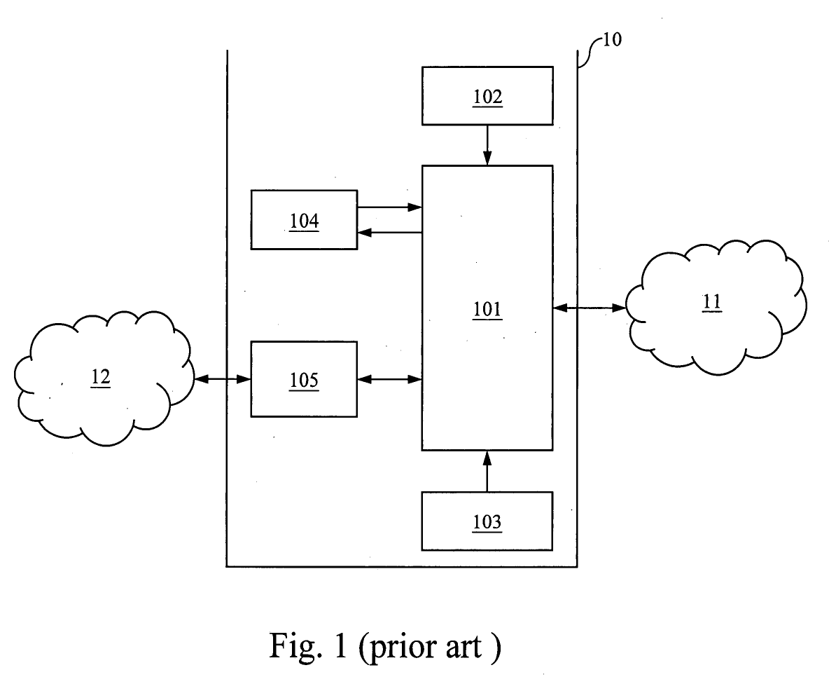

FIG. 2 is a schematic view of a conventional Internet phone composite with a conventional phone; and

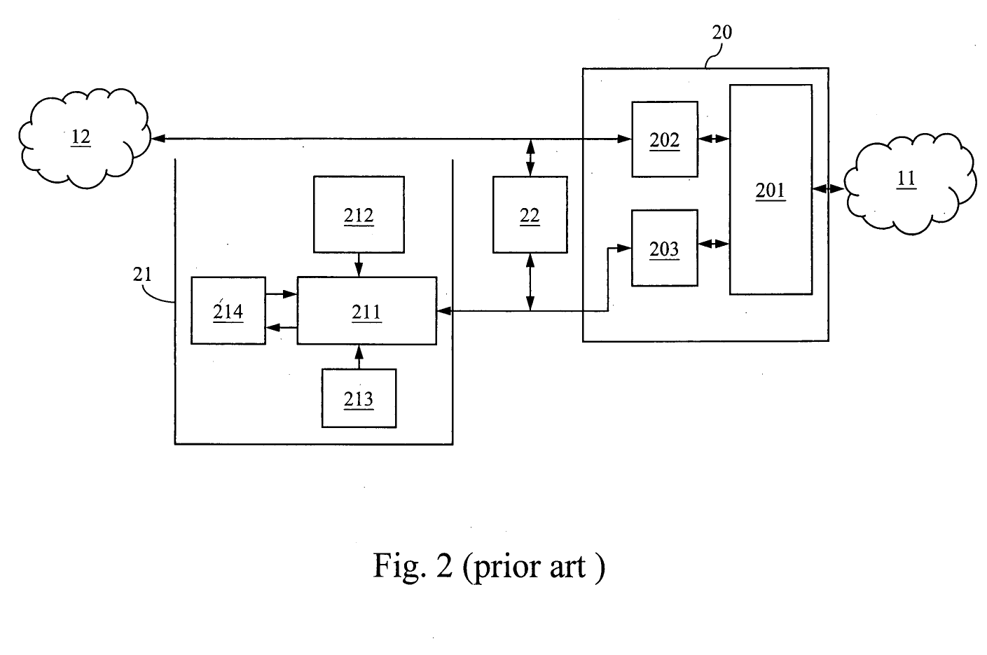

FIG. 3 is a schematic view of an Internet phone composite with the conventional phone according to the present invention.

### DETAILED DESCRIPTION OF THE INVENTION

The specific features and advantages of the present invention are illustrated in detail below, and the detailed description below is sufficient for any of those skilled in the art to appreciate the technical content of the present invention and to implement the present invention accordingly, and based upon the specification, claims and the accompanying drawings, any of those skilled in the art easily understand the relevant objects and advantages of the present invention.

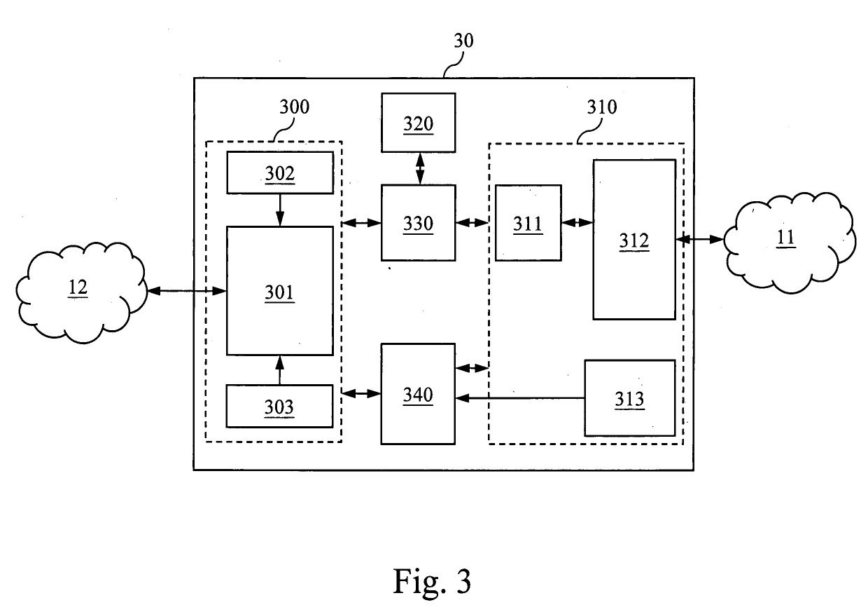

Please refer to FIG. 3 of a schematic view of an Internet phone composite with a conventional phone according to the present invention. As shown in FIG. 3, the composite Internet phone device 30 may be connected to the VOIP 11 and the PSTN 12, which comprises an Internet phone module 310, a conventional phone module 300, a receiver 320, a switching unit 330, and an isolation device 340.

The Internet phone module 310 has the same function as that of the conventional Internet phone, for example, when it is operated under an Internet phone mode, it conducts the network communication service via the VOIP 11. The Internet phone module 310 comprises a speech encoder/decoder 311 for encoding or decoding speeches, an Internet phone system 312, and an Internet phone power-supplying device 313 for supplying electric power to the Internet phone module 310 and the conventional phone module 300.

The conventional phone module 300 has the same function as a conventional phone, and when it is operated under a conventional phone mode, it conducts the communication service via the PSTN 12. The conventional phone module 300 comprises a conventional phone system 301, a hook circuit 302 for triggering the conventional phone module 300 to from a telecommunication loop with the PSTN 12, and a keypad 303.

The receiver 320 is connected to the switching unit 330 and used as an element of receiving or sending speech for this device. As the receiver 320 is switched to VOIP 11 or PSTN 12 by the switching unit 330, the user conducts the operation of receiving or sending a call with the communication destination by using the receiver 320.

The switching unit 330 is connected to the conventional phone module 300 and the Internet phone module 310, and is used to selectively connect the receiver 320 to the speech encoder/decoder 311 within the Internet phone module 310 or to the conventional phone system 301 of the conventional phone module 300.

The isolation device 340 is connected to the conventional phone module 300 and the Internet phone module 310, and is used to isolate the communication between the conventional phone mode and the Internet phone mode, so as to ensure the safety of the communication. The isolation device 340 is used to isolate the Internet phone system 312 from the conventional phone system 301.

If the communication mode is a conventional phone mode, when the user wants to dial the Internet phone, the user utilizes the Internet phone system 312 to drive or trigger the switching unit 330, thereby switching to Internet phone mode. The switching unit 330 is used manually. Then, the keypad 303 is used to dial numbers. It is transmitted from the conventional phone system 301 to the Internet phone system 312 via the isolation device 340, and thereby connecting to the VOIP 11. When the VOIP 11 has an incoming call, the Internet phone system 312 receives the calling number and then drives or triggers the switching unit 330 for being automatically switched to the Internet phone mode, thus, the user receives or sending a call via the receiver 320. However, when the power for the Internet phone power-supplying device 313 of the Internet phone module 310 is insufficient or failed, the switching unit 330 automatically switches to the conventional phone mode, such that the conventional phone module 300 may be used for conducting the communication service.

If the communication mode is an Internet phone mode, when the user wants to dial the conventional phone, the user utilizes the Internet phone system 312 to drive or trigger the switching unit 330, such that it is switched to the conventional phone mode, and then, a loop is formed together with the PSTN 12. At this point, the switching unit 330 is used manually. The user dials numbers via the keypad 303. The conventional phone system 301 receives the calling number and then connected to the PSTN 12. When the PSTN 12 has got an incoming call, the conventional phone system 301 receives the calling number and informs the Internet phone system 312 via the isolation device 340, and the Internet phone system 312 drives or triggers the switching unit 330 for automatically switching to the conventional phone mode, therefore, the user receives or sends a call via the receiver 320.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A composite Internet phone device, suitable for a voice over Internet Protocol (VOIP) and a public switched telephone network (PSTN), comprising:
an Internet phone module, wherein the composite Internet phone device is operated under an Internet phone mode, and connected to the VOIP via the Internet phone module for conducting network communication service;
a conventional phone module, wherein the composite Internet phone device is operated under a conventional phone mode, and connected to the PSTN via the conventional phone module for conducting communication service;
a switching unit, connected to the Internet phone module and the conventional phone module, for selectively switching the composite Internet phone device to the conventional phone mode or the Internet phone mode;
an isolation device, connected to the Internet phone module and the conventional phone module, for isolating the communication between the conventional phone mode and the Internet phone mode and thereby ensuring the safety of the communication; and
a power-supplying device of an Internet phone, disposed on the Internet phone module, for providing an electric power for the Internet phone module and the conventional phone module;
wherein, if the electric power for the power-supplying device of the Internet phone is insufficient or failed, the switching unit switches from the Internet phone mode to the conventional phone mode.

2. The composite Internet phone device according to claim 1, further comprises a receiver for receiving and sending a call.

3. The composite Internet phone device according to claim 1, further comprises a keypad for dialing numbers.

4. The composite Internet phone device according to claim 1, wherein the switching unit provides a manual switching function.

5. The composite Internet phone device according to claim 1, wherein the switching unit provides an automatic switching function.
